(19) United States
(12) Patent Application Publication
(10) Pub. No.: US 2022/0343319 A1
(43) Pub. Date: Oct. 27, 2022

(54) SINGLE SIGN-ON (SSO) AUTHENTICATION VIA MULTIPLE AUTHENTICATION OPTIONS

(71) Applicant: SONY GROUP CORPORATION, TOKYO (JP)

(72) Inventors: SADAYOSHI MURAO, BANGALORE (IN); SRINIVAS PINGILI, BANGALORE (IN); KOICHI ONO, TOKYO (JP)

(21) Appl. No.: 17/640,922

(22) PCT Filed: Aug. 31, 2020
(86) PCT No.: PCT/JP2020/032878

§ 371 Date: Mar. 7, 2022

Related U.S. Application Data
(63) Continuation-in-part of application No. 16/570,973, filed on Sep. 13, 2019, now Pat. No. 11,356,436.

(51) Int. Cl. G06Q 20/36; H04L 9/40

(52) U.S. Cl. CPC G06Q 20/3674; H04L 63/0815; G06Q 2220/00

(57) ABSTRACT

A hybrid authentication system, method, and a non-transitory computer-readable medium for single-sign-on (SSO) authentication via multiple authentication options is provided. The hybrid authentication system includes control circuitry communicatively coupled to a web application server and a public ledger. The control circuitry receives a request from the web application server to access secure content on a resource server and controls display of a set of user-selectable options on a user interface of a user device based on the received request. The control circuitry selects as an authentication scheme one of the web-based authentication scheme and the wallet-based authentication scheme and further controls authentication of the request based on the selected authentication scheme. The selection of the authentication is based on defined security criteria or a user input via one of the displayed set of user-selectable options.

### TECHNICAL FIELD

Various embodiments of the disclosure relate to authentication technology. More specifically, various embodiments of the disclosure relate to a system and a method for single-sign-on (SSO) authentication via multiple authentication options.

### CROSS-REFERENCE TO RELATED APPLICATIONS/INCORPORATION BY REFERENCE

None.

### BACKGROUND ART

Advancements in authentication technology have provided users with various authentication options. Conventionally, in some instances, a user can choose to use a single-sign-on (SSO) functionality whereby the user has the flexibility to sign-on to different applications based a single user account (e.g., an email or a social media account). In some other instances, multiple authentication options are also incorporated to add an additional layer of abstraction and security for authentication in less secure environments. For example, a two-factor authentication via the SSO authentication option and a one-time-password (OTP) based authentication option. Most of the conventional authentication options happen to either authenticate users in a less secure manner which in many instances leaves a possibility of a loss of critical or non-critical user information or create undesired or unacceptable hassles for users.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY OF INVENTION

A system and a method for single-sign-on (SSO) authentication via multiple authentication options, are provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

FIG. 1 is a diagram that illustrates an exemplary network environment for SSO authentication via multiple authentication options, in accordance with an embodiment of the disclosure.

FIG. 2 is a block diagram that illustrates an exemplary hybrid authentication system for SSO authentication via multiple authentication options, in accordance with an embodiment of the disclosure.

FIGS. 3A and 3B, collectively, illustrate a sequence diagram for linking a web-ID for an identity provider with a user's wallet account, in accordance with an embodiment of the disclosure.

FIGS. 3A and 3B, collectively, illustrate a sequence diagram for linking a web-ID for an identity provider with a user's wallet account, in accordance with an embodiment of the disclosure.

FIGS. 4A and 4B, collectively, illustrates a sequence diagram for a SSO authentication via multiple authentication options, in accordance with an embodiment of the disclosure.

FIGS. 4A and 4B, collectively, illustrates a sequence diagram for a SSO authentication via multiple authentication options, in accordance with an embodiment of the disclosure.

FIG. 5 is an example diagram that illustrates association among a user identifier, multiple user accounts, and multiple web accounts or multiple web-IDs, in accordance with an embodiment of the disclosure.

FIG. 6 is a flowchart that illustrates an exemplary method for SSO authentication via multiple authentication options, in accordance with an embodiment of the disclosure.

### DESCRIPTION OF EMBODIMENTS

The following described implementations may be found in the disclosed system and method for single-sign-on (SSO) authentication via multiple authentication options. Exemplary aspects of the disclosure provide a hybrid authentication system for SSO authentication. The hybrid authentication system may be a Single Sign-in system that provides a user with multiple authentication options for a web application. By way of example, the hybrid authentication system provides two authentication options, namely a web-based authentication and a wallet-based authentication. The web-based authentication may be based on the Oauth protocol, whereby an identity provider, such as an Oauth server, may be responsible for authentication of requests to access user-specific information on resource servers (also referred to as API servers). Whereas, the wallet-based authentication may be based on a smart contract stored on a public ledger and a private key associated with user's wallet account on the public ledger. The smart contract may store an access token pre-shared by the identity provider, a wallet address for the user's wallet account, and a status identifier that indicates whether the user's wallet account is linked to a web-ID (or. a web account) of an identity provider.

The hybrid authentication system provides a flexibility to a user to select two-factor authentication or one of the two-factor authentication, i.e. one of or both web-based authentication and wallet-based authentication. For example, the user has the flexibility to SSO to the web application using usual login credentials (e.g., an Email ID/phone number and a password) or the user can SSO to the web application by logging to the user's wallet account on the public ledger using a wallet ID and a private key for the user's wallet account. Additionally, or alternatively, security criteria may be defined based on whether to select two-factor authentication or one of the two-factor authentication. By way of example, the security criteria may include a defined security level (e.g., a user-defined security level) for a specific web application hosted on a web application server, a user preferred authentication for the specific web application, or a failure status of the authentication attempted previously based on one of the web-based authentication or the wallet-based authentication. For SSO access based on the wallet-based authentication, an initialized session on a web client of the user device may be issued a session ID as that for a session initialized based on a web-based login. Thus, after sign-on to the web application, the state of the client-end interface may remain same for the user, notwithstanding the selection of either of the authentication options.

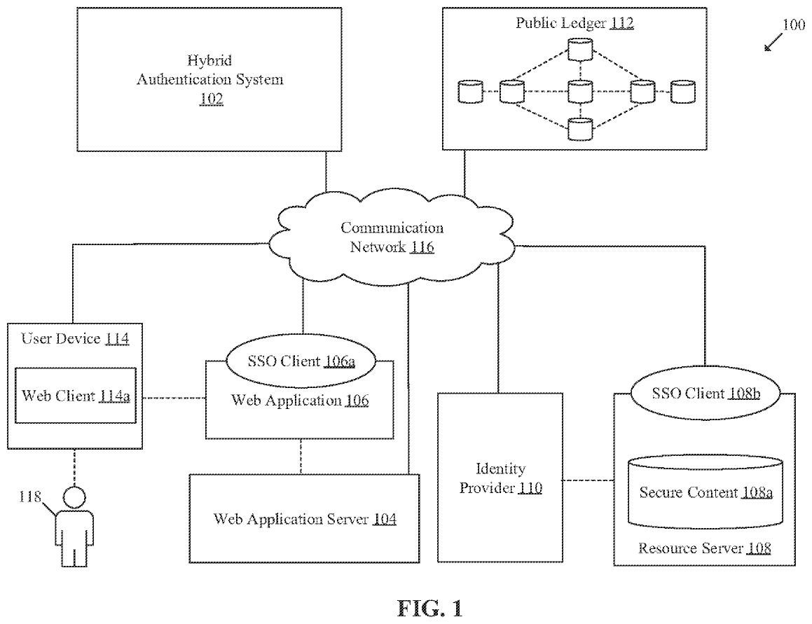

FIG. 1 is a diagram that illustrates an exemplary network environment for SSO authentication via multiple authentication options, in accordance with an embodiment of the disclosure. With reference to FIG. 1, there is shown a network environment 100. The network environment 100 includes a hybrid authentication system 102, a web application server 104, and a web application 106 hosted on the web application server 104. The network environment 100 further includes a resource server 108, an identity provider 110, a public ledger 112, and a user device 114 that hosts a web client 114a, for example, a web browser. An SSO client 106a and an SSO client 108b may reside on the web application 106 and the resource server 108, respectively. The network environment 100 further includes a communication network 116. The communication network 116 may be established among two or more computing devices of the network environment 100. By way of example, the communication network 116 may be among the hybrid authentication system 102, the web application server 104, the identity provider 110, the resource server 108, the public ledger 112, and the user device 114. There is further shown a user 118 associated with the user device 114.

The hybrid authentication system 102 may comprise suitable logic, circuitry, and interfaces that may be configured to execute operations related to identity (ID) management for users and/or web applications requesting access to the secure content 108a on the resource server 108. The hybrid authentication system 102 may be configured to control authentication and/or an authentication level (e.g., single-factor or two-factor authentication) of a request to access the secure content 108a on the resource server 108. By way of example, the request may be provided by the web application server 104 based on receipt of a user-initiated request for a SSO access to at least one web application (such as the web application 106) hosted on the web application server 104. Additionally, the hybrid authentication system 102 may handle operations associated with maintenance of authentication state of the request and access-profile management for users and/or web applications. Examples of the hybrid authentication system 102 may include, but are not limited to, a server, a distributed network of servers, a computing device, a mainframe machine, a computer work-station, and/or a consumer electronic (CE) device.

The web application server 104 may comprise suitable logic, circuitry, and interfaces that may be configured to host at least one web application. By way of example, the web application server 104 may host a server-side logic, a server-side program, and application data for the web application 106. Whenever the user 118 requests the web application server 104 to access a functionality of the web application 106 via the web client 114a, the web application server 104 executes the server-side program and the server-side logic for the web application so as to fulfill the request. Examples of the web application server 104 may include, but are not limited to, a server, a remote server, a computing device, a mainframe machine, a computer work-station, and/or a consumer electronic (CE) device.

The web application 106 may be a client-server computer-implemented program and may include, for example, a client-side interface, a client-side logic, a server-side program, and a server-side logic. The web application 106 may be one of the one or more web applications hosted on the web application server 104. By way of example, the client-side interface may be a web-page loaded on the web browser. The client-side logic may be a program that uses a web technology, such as ASP, JSP/Java, Node.js, PHP, or Python, to receive requests from the web-page and process the requests as queries, updates or actions for the server-side program. Examples of the web application 106 may include, but are not limited to, a webpage-based application that loads up in a web browser, a mobile application, a native web application, a desktop-based web application.

The SSO client 106a may be an application that resides on the web application 106 hosted on the web application server 104. The SSO client 106a may provide an interface to the hybrid authentication system 102 for access, interactivity, and/or exchange of information with the web application 106 and/or the web client 114a of the user device 114. By way of example, the SSO client 106a may provide a set of services related to SSO access to the user via a web browser (i.e. the web client 114a). An SSO agent (not shown in FIG. 1) on the hybrid authentication system 102 may communicate with the SSO client 106a. By way of example, the SSO client 106a may enable the hybrid authentication system 102 to retrieve user credentials from the web client 114a of the user device 114 or to push a user interface that triggers the user to provide the user credentials for SSO access to the web application 106.

The resource server 108 may comprise suitable logic, circuitry, and interfaces that may be configured to store the secure content 108a, for example, the user-specific information or Personal Identifiable Information (PII) associated with the user 118. The secure content 108a may be sufficient to establish identity of the user 118. By way of example, as per Oauth 2.0, the resource server 108 may be also referred to as an application-programming interface (API) server and may be configured to handle requests related to authentication of web applications having valid access credentials to access the secure content 108a.

The identity provider 110 may be a server, a network of servers, an online service, or a website that issues access credentials on behalf of the user 118 to the web application 106 so as enable the web application 106 to access the secure content 108a from the resource server 108. Also, the identity provider 110 may offer SSO-as-a-service to the web application 106 as a client. The resource server 108 may be managed by the identity provider 110. For Oauth-based authentication, the identity Provider 110 may be an Oauth Server which may issue access credentials on behalf of the user 118 to the web application 106. Examples of the identity provider 110 may include, but are not limited to, email-service providers, social-media networks, or other web-based login services.

The public ledger 112 may be a decentralized, distributed, and public database system that maintains an immutable record of data operations or transactions. A set of data operations may be grouped together as a block and may be further linked to a previous block of data operations to form a chain. All blocks of data operations may be stored in a decentralized manner, whereby all participants or public nodes store all the blocks. Further, the public ledger 112 may include an operating system which allows for deployment of a smart contract between multiple parties, for example, the user and the hybrid authentication system 102. Herein, the smart contract may be a self-executable program or a computer code that may run on the public ledger 112 and may include a set of conditions under which multiple parties to the smart contract agree to interact with each other. The smart contract may be stored at a specific address on the public ledger 112 and may be a collection of the computer code (i.e. functions) and data (i.e. the state of account).

By way of example, the public ledger 112 may be an Ethereum blockchain which uses accounts as state objects and a state of each account can be tracked by the Ethereum blockchain. Herein, the accounts represent identities of users, mining nodes, or automated agents. All the blocks of data operations or the smart contract are associated with the accounts on the Ethereum Blockchain.

The user device 114 may comprise suitable logic, circuitry, and interfaces that may be configured to access the web application 106 via the web client 114a on the user device 114. For example, the web client 114a may be a web browser that loads up a client-side interface of a multimedia streaming application. The web client 114a on the user device 114 may have provisions to generate a user-initiated request for an SSO access to the multimedia streaming application based on identity information/credentials of the user 118, as maintained on the resource server 108 by the identity provider 110, for example, a social media account or an Email account. The user device 114 may include suitable Input/output (I/O) functionality and networking functionality to facilitate a communication of the web client 114a with the web application server 104 and/or the hybrid authentication system 102. Examples of the user device 114 may include, but is not limited to, a computing device, a mobile phone, a smart phone, a computer work-station, and/or any consumer electronic (CE) device.

The web client 114a may be a computer application, such as a web browser on the user device 114. The web client 114a may correspond to a platform on the user device 114 to access a client-side interface of the web application 106 hosted on the web application server 104.

The communication network 116 may include a communication medium through which the hybrid authentication system 102, the web application server 104, the resource server 108, the identity provider 110, the public ledger 112, and the user device 114 may communicate with each other. Examples of the communication network 116 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 116, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the web application server 104 may host one or more web applications, such as the web application 106. On the user device 114, the web client 114a may receive a first user input (e.g., a Uniform Resource Locator (URL) for the web application) to access the client-side interface of the web application 106. Once the client-side interface is loaded and displayed on a user interface of the user device 114, the web client 114a may receive a second user input as a request for an SSO access to the web application, via the client-side interface. The second user input may be provided to trigger a process for the SSO access to the web application 106 and to gain access to a plurality of systems or services associated with the web application 106 using a single sign-on credential provided by the identity provider 110.

The web application server 104 may receive a user-initiated request for the SSO access to the web application 106. Based on the receipt of the user-initiated request, the web application server 104 may further generate and transmit a request to the hybrid authentication system 102. The request may be transmitted to initiate an authentication process so as to access the secure content 108a on the resource server 108. The secure content 108a may include user-specific information, such as user name, Email-ID, age, gender, Date of Birth (DOB), user location, and the like. The web application server 104 may need access to the user-specific information so as to login or sign-up the user for the web application 106 and/or to create/verify the identity of the user 118.

The hybrid authentication system 102 may be configured to receive the request from the web application server 104 to access the secure content 108a on the resource server 108. The hybrid authentication system 102 may be further configured to control display of a set of user-selectable options on a user interface of the user device 114 based on the received request from the web application server 104. As an example, the user interface may be a web page or a popup window that displays the set of user-selectable options. The set of user-selectable options may correspond to a web-based authentication scheme and a wallet-based authentication scheme. The web-based authentication scheme may be based on the Oauth (e.g., Oauth 2.0) Protocol and may correspond to a first authentication option of a two-factor authentication option. The wallet-based authentication scheme may be based on the smart contract stored on the public ledger 112.

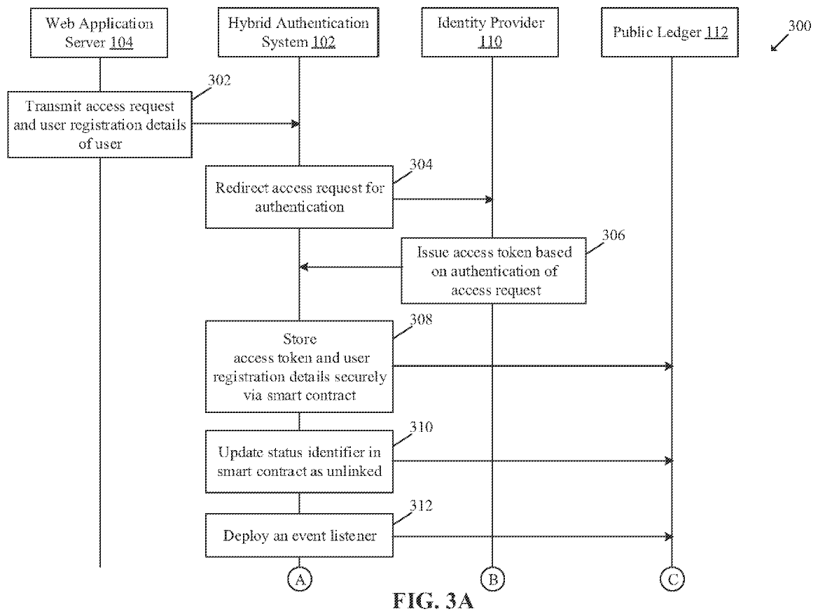

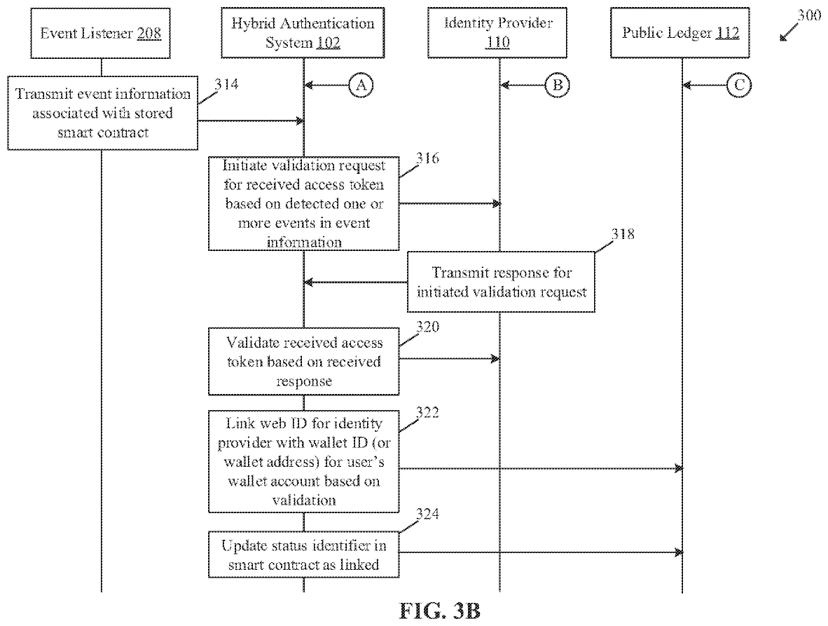

The smart contract may store a wallet address, an access token for the resource server 108, a user identifier, and a status identifier on the public ledger 112. It may be noted here that the access token may be pre-shared by the identity provider 110 based on authentication of an access request provided by the web application server 104. By way of example, the identity provider 110 may pre-share an Oauth token as the access token with the web application server 104 based on a past authentication using Oauth protocol. Details of operations to obtain the access token are provided, for example, in FIG. 3A and FIG. 3B.

The wallet address may be utilized for a user's wallet account (i.e. a wallet account for the user 118) on the public ledger 112. The access token may include a unique string which may indicate that the bearer of the access token is authorized to access the resource server 108 and is allowed to execute specific operations (e.g., data retrieval) on the resource server 108, as per a scope granted for the access token. Further, the access token may be linked to the user identifier and stored together on the public ledger 112. Details of operations to obtain the access token from the identity provider 110 are provided, for example, in FIG. 3A and FIG. 3B.

The status identifier may indicate whether one of the wallet address or a wallet identity (ID) for the user's wallet account is linked or unlinked to a web-ID (or a web account) of the identity provider 110. In certain instances, multiple web accounts (or web-IDs) may be linked to the user's wallet account so as to allow the user 118 to select any suitable web-ID for SSO access to the web application. The linkage of the wallet address or the wallet ID for the user's wallet account with the web-ID(s) is described, for example, in FIG. 3A and FIG. 3B.

The hybrid authentication system 102 may be further configured to select as an authentication scheme one of: the web-based authentication scheme and the wallet-based authentication scheme. The authentication scheme may be selected based on a defined security criteria or a user input from the user 118 via one of the displayed set of user-selectable options. By way of example, the defined security criteria may include a defined security level for a specific web application of the one or more web applications hosted on the web application server 104. The defined security criteria may be used to determine whether to further select a single factor authentication or a two-factor authentication for the request initiated by the web application server 104. In certain exemplary scenarios, for the two-factor authentication, other authentication schemes, for example, one-time-password (OTP)-based authentication or Pin-based authentication, may be selected as a secondary authentication factor with the selected authentication scheme as the primary authentication factor. Additionally, or alternatively, the defined security criteria may include a user preferred authentication scheme for the specific web application. As an example, based on historical user preference or historical selections of the authentication scheme, a record of the user preferred authentication scheme for different web applications may be maintained by the hybrid authentication system 102.

Additionally, or alternatively, the defined security criteria may include a failure status of authentication attempted previously based on one of the web-based authentication scheme or the wallet-based authentication scheme. For example, historical records of authentication failures and/or logs of failed attempts to authenticate the request of the web application server 104 using the web based authentication scheme may be analyzed to select the wallet-based authentication scheme as the selected authentication scheme and to reattempt the authentication based on the wallet-based authentication scheme.

The hybrid authentication system 102 may be further configured to control the authentication of the received request based on the selected authentication scheme. In an embodiment, the hybrid authentication system 102 may be configured to receive the user input via a first user-selectable option of the displayed set of user-selectable options for a selection of the web-based authentication scheme. The hybrid authentication system 102 may be further configured to select the authentication scheme as the web-based authentication scheme based on the received user input from the user 118. The hybrid authentication system 102 may be further configured to control the authentication of the received request, in accordance with the web-based authentication scheme. By way of example, the web-based authentication scheme may follow the Oauth 2.0 protocol (hereinafter, referred to as Oauth protocol). The Oauth protocol is an open standard for token-based authentication and authorization and provides a standard way to access services that require user authorization API for the web application 106. Oauth protocol is known to one ordinarily skilled in the art; therefore, details of the Oauth protocol is omitted from the disclosure for the sake of brevity.

Once the web-based authentication scheme is selected, the hybrid authentication system 102 may be configured to determine whether the access token is expired and a new access token is to be requested. In case the access token is not expired, the hybrid authentication system 102 may be configured to control the authentication of the received request based on the access token, generated by the identity provider 110. By way of example, the authentication may be controlled by dispatching a token-exchange process between the web application server 104 and the resource server 108. More specifically, the web application server 104 may retrieve the access token and transmit the access token to the resource server 108. The resource server 108 may validate the access token and verify the identity of a bearer of the access token and authorize the web application server 104 to access the secure content 108a.

In another embodiment, the hybrid authentication system 102 may be configured to receive the user input via a second user-selectable option of the displayed set of user-selectable options for a selection of the wallet-based authentication scheme. The hybrid authentication system 102 may be further configured to select the authentication scheme as the wallet-based authentication scheme based on the received user input from the user 118. The hybrid authentication system 102 may be further configured to control the authentication of the received request in accordance with the wallet-based authentication scheme. Once the wallet-based authentication scheme is selected, the hybrid authentication system 102 may be configured to determine whether the access token is expired and a new access token is to be requested. In case the access token is not expired, the hybrid authentication system 102 may be configured to control the authentication of the received request by dispatching a wallet-based authentication process.

In the wallet-based authentication process, the hybrid authentication system 102 may be configured to trigger a prompt on the web client 114a of the user device 114 based on the received user input. The prompt may be triggered so as to enable a user login to the user's wallet account on the public ledger 112. For example, the prompt may be triggered to enable the user login to the user's wallet account, via the web client 114a on the user device 114. The user login to the user's wallet account may be enabled using the wallet address and a private key associated with the wallet address for the user's wallet account. The private key associated with the user's wallet account may be accessible to the user 118 only.

The hybrid authentication system 102 may be further configured to detect the user login to the user's wallet account on the public ledger 112. The user 118 may input for example, the wallet ID and the private key or a password for the user's wallet account to perform the user login via the prompt triggered in the web client 114a. The hybrid authentication system 102 may be further configured to control the authentication of the received request based on the public key associated with the wallet address, the detection of the user login, and the smart contract. The public key associated with the wallet address may be stored on the hybrid authentication system 102.

The hybrid authentication system 102 may be further configured to share an authentication credential with the web application server 104 based on the authentication of the received request. The authentication credential may correspond to a credential that the hybrid authentication system 102 may provide to the web application server 104 so as to indicate that the request from the web application server 104 to access the secure content 108a is authenticated. The web application server 104 may receive the authentication credential from the hybrid authentication system 102, via the SSO client 106a. Thereafter, the web application server 104 may access the secure content 108a on the resource server 108 using the shared authentication credential. By way of example, the resource server 108A may receive the authentication credential from the web application server 104 to access the secure content 108a. The SSO client 108b on the resource server 108 may verify the received authentication credential with the hybrid authentication credential. The resource server 108 may validate the request to access the secure content 108a based on the verification of the shared authentication credential. Additionally, or alternatively, the resource server 108 may verify that the request to access the secure content 108a is from a valid token bearer, i.e. the web application 106.

The web application server 104 may initialize a session of the web application 106 on the web client 114a of the user device 114 based on the accessed secure content 108a. The web application 106 may assign a session ID to the initialized session on the web client 114a on the user device 114. The assigned session ID may be the same as that for a sign-on based on a web-based login. In other words, the assigned session ID may be the same as a session ID that may be assigned to the web application 106 for the web-based login on the web client 114a.

In some exemplary embodiments, the hybrid authentication system 102 may be configured to construct a user profile image based on the authentication of the received request. The user profile image may include an application Uniform Resource Locator (URL) for one or more web applications hosted on the web application server 104, an authentication type, an identity provider name, an expiration time pre-assigned to an access token, and a re-certification status. For example, the user profile image for the user 118 may include the URL for the web application 106 hosted on the web application server 104 via the web client 114a. The user profile image for the user 118 may further include the authentication type which may be specify the authentication scheme(s) to be selected for the authentication of requests from a specific web application. For example, the authentication type may be a web-based authentication, a wallet-based authentication, or both the web-based authentication and the wallet-based authentication. The user profile image for the user 118 may further include a name of the identity provider 110 and an expiration time pre-assigned to the access token provided by the identity provider 110. The user profile image for the user 118 may further include the re-certification status that indicates whether a recertification for the SSO access is required or not required for the user 118 in future.

An example of the user profile image is provided in Table 1, as follows:

TABLE 1
User Profile Image for Hybrid Authentication Setup

| Application | Authentication | Web Account | Expiration | | Re-certification |
|---|---|---|---|---|---|
| URL | Type | (Web IDs) | Time | | (SSO) |
| http://123.com | Both (Web, | ID_Provider_1, | 72 | Hours | Mandatory |
| | Wallet) | ID_Provider_2 | | | |
| http://abc.com | Wallet Only | ID_Provider_3, | 0.5 | Hour | None |
| | | ID_Provider_2 | | | |
| http://xyz.com | One of (Web, | ID_Provider_4 | 12 | Hours | None |
| | Wallet) | | | | |

In Table 1, the web account (ID_Provider_1, ID_Provider_2, ID_Provider_3, and ID_Provider_4) may correspond to multiple identity providers. Corresponding web accounts (or web-IDs) of the multiple identity providers may be linked to the wallet ID or wallet address of the user's wallet account so as to allow a user to select SSO authentication via different web accounts/web-IDs.

In some exemplary embodiments, the hybrid authentication system 102 may be further configured to provide a two-factor authentication scheme for the authentication of the received request. The two-factor authentication scheme may include both the web-based authentication scheme and the wallet-based authentication scheme for the authentication of the received request. The hybrid authentication system 102 may be further configured to control the authentication of the request, in accordance with both the web-based authentication scheme and the wallet-based authentication scheme.

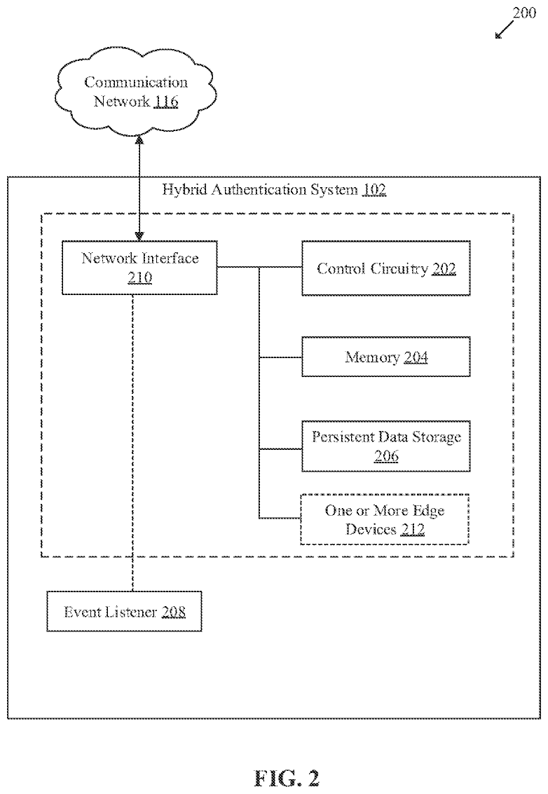

FIG. 2 is a block diagram that illustrates an exemplary hybrid authentication system for SSO authentication via multiple authentication options, in accordance with an embodiment of the disclosure. FIG. 2 is explained in conjunction with elements from FIG. 1. With reference to FIG. 2, there is shown a block diagram 200 of the hybrid authentication system 102. The hybrid authentication system 102 may include control circuitry 202, a memory 204, and a persistent data storage 206. The hybrid authentication system 102 may further include an event listener 208 and a network interface 210. The control circuitry 202 may be configured to communicate with the web application server 104, the resource server 108, the public ledger 112, the identity provider 110, and the user device 114 by use of the network interface 210. Also, the control circuitry 202 may be communicatively coupled to the memory 204, the persistent data storage 206, the event listener 208 and the network interface 210.

The control circuitry 202 may comprise suitable logic, circuitry, and interfaces that may be configured to receive the request from the web application server 104 to access the secure content 108a on the resource server 108. The control circuitry 202 may be further configured to select one of the web-based authentication scheme and the wallet-based authentication scheme for authentication of the received request. The authentication scheme may be selected based on the defined security criteria or a user input via the user device 114. The control circuitry 202 may be further configured to control authentication of the received request based on the selected authentication scheme. The control circuitry 202 may include one or more processors configured to execute instructions stored in the memory 204 and may include one or more specialized processing units, which may be implemented as a separate processor or circuitry in the hybrid authentication system 102.

In an embodiment, the one or more specialized processing units and the control circuitry 202 may be implemented as an integrated processor or a cluster of processors that perform the functions of the one or more specialized processing units and the control circuitry 202, collectively. The control circuitry 202 may be implemented based on a number of processor technologies known in the art. Examples of implementations of the control circuitry 202 may be an x86-based processor, a Reduced Instruction Set Computing (RISC) processor, an Application-Specific Integrated Circuit (ASIC) processor, a Complex Instruction Set Computing (CISC) processor, a microcontroller, a central processing unit (CPU), a Graphics Processing Unit (GPU), and/or other control circuits.

The memory 204 may comprise suitable logic, circuitry, and interfaces that may be configured to store program instructions executable by the control circuitry 202. In certain embodiments, the memory 204 may be configured to store operating systems and associated application-specific information. The memory 204 may include computer-readable storage media for carrying or having computer-executable instructions or data structures stored thereon. Such computer-readable storage media may include any available media that may be accessed by a general-purpose or special-purpose computer. Such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the control circuitry 202 to perform a certain operation or group of operations associated with the hybrid authentication system 102.

The persistent data storage 206 may comprise suitable logic, circuitry, and interfaces that may be configured to store program instructions executable by the control circuitry 202, operating systems, and/or application-specific information, such as logs and application-specific databases. The persistent data storage 206 may include computer-readable storage media for carrying or having computer-executable instructions or data structures stored thereon. Such computer-readable storage media may include any available media that may be accessed by a general-purpose or special-purpose computer. By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the control circuitry 202 to perform a certain operation or group of operations associated with the hybrid authentication system 102.

The event listener 208 may comprise suitable logic, circuitry, and interfaces that may be configured to detect one or more events associated with the stored smart contract on the public ledger 112. The event listener 208 may be deployed by the control circuitry 202 on the public ledger 112 so as to detect the one or more events associated with the stored smart contract on the public ledger 112. The one or more events may correspond to one or more records associated with the smart contract for the user's wallet account on the public ledger 112. The event listener 208 may be implemented based on program code/software program and/or a number of processor technologies known in the art.

The network interface 210 may comprise suitable logic, circuitry, and interfaces that may be configured to facilitate communication between the hybrid authentication system 102, the web application server 104, the resource server 108, the identity provider 110, the public ledger 112, and the user device 114, via the communication network 116. The network interface 210 may be implemented by use of various known technologies to support wired or wireless communication of the hybrid authentication system 102 with the communication network 116. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 210 may be configured to communicate via wireless communication with networks, such as the Internet, an Intranet or a wireless network, such as a cellular telephone network, a wireless local area network (LAN), and a metropolitan area network (MAN).

The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

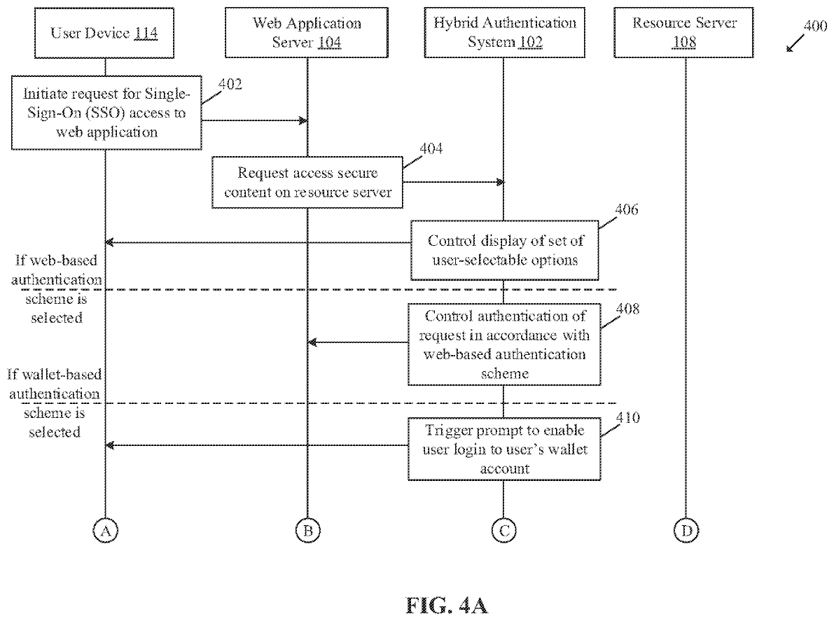

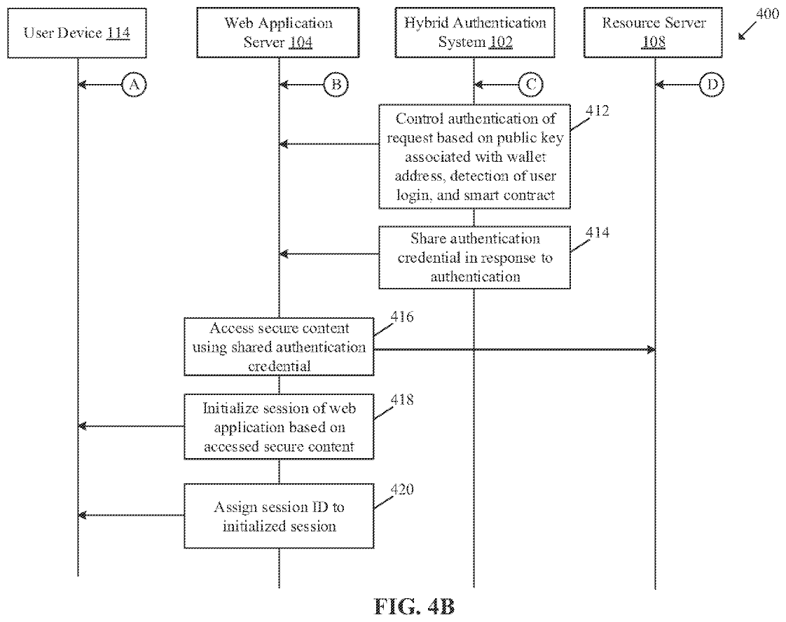

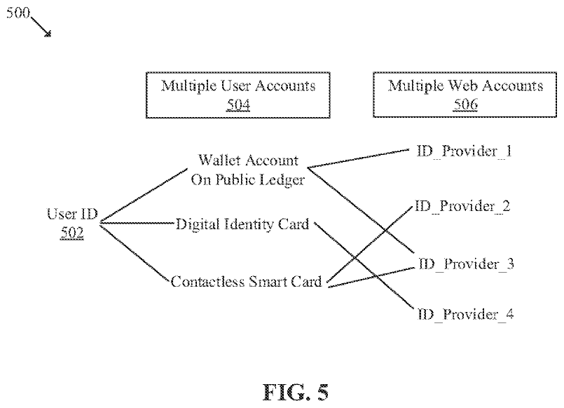

In some exemplary embodiments, the hybrid authentication system 102 may further include one or more edge devices 212 which may be configured to perform the wallet-based authentication of the request from the web application server 104. Each edge device of the one or more edge devices 212 may be provide an entry point into an enterprise or a service provider core network. The one or more edge devices 212 may include, for example, a router, a routing switch, an integrated access device (IAD), multiplexer, and a variety of MAN and WAN access device. The operations executed by the control circuitry 202 are described in detail, for example, in FIG. 3A, FIG. 3B, FIG. 4A, FIG. 4B, and FIG. 5.

FIGS. 3A and 3B, collectively, illustrate a sequence diagram for linking a web-ID for an identity provider with a user's wallet account, in accordance with an embodiment of the disclosure. FIGS. 3A and 3B are explained in conjunction with elements from FIG. 1 and FIG. 2. With reference to FIGS. 3A and 3B, there is shown a sequence diagram 300 that illustrates a method for linking a web-ID for the identity provider 110 with a public key for a user's wallet account. The sequence of operations may be from 302 to 324 which may be executed by various elements of the network environment 100, such as the hybrid authentication system 102, the web application server 104, the identity provider 110, and the public ledger 112.

At 302, the web application server 104 may transmit an access request and user registration details of the user 118 to the hybrid authentication system 102. The access request may be transmitted to obtain an access token from the identity provider 110. The web application server 104, i.e. token bearer, is authenticated on behalf of the user 118 to access the secure content 108a associated with the user 118, from the resource server 108. Also, the access request and user registration details may be transmitted to the hybrid authentication system 102 based on a user's request for SSO on the web application 106, via the web client 114a of the user device 114.

At 304, the hybrid authentication system 102 may be configured to redirect the access request to the identity provider 110 for authentication. The hybrid authentication system 102 may be configured to receive the access request and the user registration details of the user 118 from the web application server 104. For example, the hybrid authentication system 102 may be configured to redirect the access request to a web page of the identity provider 110.

At 306, the identity provider 110 may be configured to issue an access token based on authentication of the access request. As an example, the access token may be an Oauth token issued by the identity provider 110, in accordance with the Oauth protocol. The identity provider 110 may be configured to authenticate the access request and an identity of the user 118 based on the user registration details of the user 118. The identity provider 110 may be further configured to generate the access token associated with the access request of the user 118. The access token may include a unique string which may represent that the bearer of the access token is authorized to access the resource server 108 and is allowed to execute specific operations (e.g., data retrieval) on the resource server 108, as per a scope granted for the access token.

At 308, the hybrid authentication system 102 may be further configured to store the access token and the user registration details on the public ledger 112 securely, via a smart contract. The smart contract may be a self-executable program that stores a wallet address, a user identifier, and a status identifier, and the access token for the resource server 108, on the public ledger 112. The smart contract itself may be stored on the public ledger 112.

The wallet address may be for a user's wallet account, such as the wallet account of the user 118. The status identifier stored in the smart contract may indicate whether the wallet address or a wallet ID for the user's wallet account is linked or unlinked to a web-ID for the identity provider 110. Herein, the web-ID may be a unique way for identifying a company, an organization, or an agent by use of a uniform resource identifier (URI). The web-ID for the identity provider 110 may be a pre-specified URI, which may be a string of characters that may be used to identify the identity provider 110 unambiguously. The wallet account of the user 118 on the public ledger 112 may be a cryptographic wallet account of the user 118 on the public ledger 112. The wallet account of the user 118 on the public ledger 112 may be associated with a public key and a private key. The wallet ID for the user's wallet account may be a unique ID assigned to the user's wallet account on the public ledger 112.

At 310, the hybrid authentication system 102 may be configured to update the status identifier in the smart contract as unlinked. The unlinked status identifier may indicate that the wallet ID (or the wallet address) for the user's wallet account is unlinked to the web-ID for the identity provider 110. Initially, the wallet ID (or the wallet address) may be unlinked to the web-ID and therefore, the status identifier may be updated as Unlinked. An example record of a wallet address, a user identifier, a status identifier, and an access token, as stored on the public ledger 112, is provided in Table 2, as follows:

TABLE 2
Example Record on Public Ledger

| Web ID | Access Token | Wallet ID | Status Identifier |
|---|---|---|---|
| 123 | 45ffsd4 | 0x23ddf4 | Unlinked |

At 312, the hybrid authentication system 102 may be further configured to deploy the event listener 208 on the public ledger 112. The hybrid authentication system 102 may be further configured to use the deployed event listener 208 to detect one or more events associated with the stored smart contract on the public ledger 112. The one or more events may correspond to one or more records associated with the smart contract of the user's wallet account on the public ledger 112. For example, an event may correspond to a record of a current user activity associated with the user's wallet account on the public ledger 112.

At 314, the event listener 208 may be configured to transmit event information associated with the stored smart contract to the hybrid authentication system 102. The event information may include the detected one or more events associated with the stored smart contract on the public ledger 112. For example, a detected event may correspond to a user login to the user's wallet account on the public ledger 112.

At 316, the hybrid authentication system 102 may be further configured to initiate a validation request for the received access token with the identity provider 110 based on the detected one or more events on the public ledger 112. The identity provider 110 may be configured to determine whether the received access token is valid.

At 318, the identity provider 110 may be further configured to transmit a response for the initiated validation request to the hybrid authentication system 102. The response may include information that may indicate whether the access token is valid or not. For example, if the received access token is valid, the identity provider 110 may be configured to transmit the response indicating that the received access token is valid to the hybrid authentication system 102. Alternatively, if the received access token is invalid, the identity provider 110 may be configured to transmit the response indicating that the received access token is invalid to the hybrid authentication system 102. The hybrid authentication system 102 may be configured to receive the response from the identity provider 110.

At 320, the hybrid authentication system 102 may be further configured to validate the received access token based on the received response from the identity provider 110. The hybrid authentication system 102 may be further configured to validate the received access token if the received response from the identity provider 110 validates the access token. Alternatively, the hybrid authentication system 102 may be configured to invalidate the received access token if the received response from the identity provider 110 invalidates the access token associated with the user 118.

At 322, the hybrid authentication system 102 may be further configured to link the web-ID for the identity provider 110 with the wallet ID (or the wallet address) for the user's wallet account based on the validation of the received access token. For example, if the identity provider 110 is an email service provider, the hybrid authentication system 102 may be configured to link the web-ID for the email service provider with the wallet ID (or the wallet address) for the user's wallet account on the public ledger 112.

Additionally, or alternatively, the user's wallet account may be linked to a plurality of web-IDs for corresponding plurality of identity providers. The hybrid authentication system 102 may be further configured to link the plurality of web-IDs for the corresponding plurality of identity providers with the wallet ID (or the wallet address) of the user's wallet account on the public ledger 112. For example, with an email service provider, and one or more social media network providers as identity providers, the hybrid authentication system 102 may be configured to link the web-IDs for the identity providers with the wallet ID (or the wallet address) for the user's wallet account.

At 324, the hybrid authentication system 102 may be further configured to update the status identifier in the smart contract as linked, based on the linkage between the web-ID for the identity provider 110 with the wallet ID (or the wallet address) for the user's wallet account. The updated status identifier that includes the web-ID for the identity provider 110 may be stored on the public ledger 112 and may indicate an association between the wallet ID (or the wallet address) and the web-ID for the identity provider 110. An example record of a web-ID, an access token, a wallet ID, and the updated status identifier on the public ledger 112, is provided in Table 3, as follows:

TABLE 3
Updated Record on Public Ledger

| Web ID | Access Token | Wallet ID | Status Identifier |
|---|---|---|---|
| 123 | 45ffsd4 | 0x23ddf4 | Linked |

FIGS. 4A and 4B, collectively, illustrates a sequence diagram for a SSO authentication via multiple authentication options, in accordance with an embodiment of the disclosure. FIGS. 4A and 4B are explained in conjunction with elements from FIG. 1, FIG. 2, FIG. 3A, and FIG. 3B. With reference to FIGS. 4A and 4B, there is shown a sequence diagram 400 that illustrates a method for SSO authentication via multiple authentication options. The sequence of operations may be from 402 to 420 which may be executed by various elements of the network environment 100, such as by the hybrid authentication system 102, the web application server 104, the resource server 108, and the user device 114.

At 402, the user device 114 may request for an SSO access to the web application 106 of the web application server 104. The request for the SSO access may be initiated by the user 118, via the web client 114a and may be communicated to the web application server 104.

At 404, the web application server 104 may request an access to the secure content 108a on the resource server 108. The request may be provided to the hybrid authentication system 102 based on the receipt of the user's request for SSO access to the web application 106 by the user 118. The access to the secure content 108a may be required to provide a particular service of the web application 106 to the user 118 via the web client 114a of the user device 114.

At 406, the hybrid authentication system 102 may be configured to control display of the set of user-selectable options on the user interface of the user device 114 based on the received request from the web application server 104. The set of user-selectable options may correspond to the web-based authentication scheme and the wallet-based authentication scheme.

At 408, if the web-based authentication scheme is selected for the authentication of the request, the hybrid authentication system 102 may be configured to control the authentication of the request in accordance with the web-based authentication scheme. The authentication scheme may be selected based on a defined security criteria or a user input via one of the displayed set of user-selectable options. The web-based authentication scheme may be based on the Oauth protocol. Details of the web-based authentication scheme are provided, for example, in FIG. 1.

At 410, if the wallet-based authentication scheme is selected for the authentication of the request, the hybrid authentication system 102 may be configured to trigger a prompt on the web client 114a of the user device 114 based on the received user input. The prompt may be triggered so as to enable a user login to the user's wallet account on the public ledger 112, for example, an Ethereum Blockchain. By way of example, the user login to the user's wallet account may be based on the wallet address and the private key associated with the wallet address for the user's wallet account. The hybrid authentication system 102 may be further configured to detect, via the web client 114a, the user login to the user's wallet account on the public ledger 112.

At 412, the hybrid authentication system 102 may be further configured to control the authentication of the request based on the public key associated with the wallet address, the detection of the user login, and the smart contract. By way of example, the request may be authenticated based on verification of the user login to the user's wallet account and further based on the public key associated with the user's wallet account and the access token stored on the public ledger 112 and linked to the smart contract.

At 414, the hybrid authentication system 102 may be configured to share the authentication credential with the web application server 104 based on the authentication of the received request. The authentication credential may include information which may represent that the bearer of the authentication credential is authorized to access the secure content 108a on the resource server 108. Also, the authentication credential may be provided by the hybrid authentication system 102 to the web application server 104 so as to indicate that the request from the web application server 104 to access the secure content 108a is authenticated.

At 416, the web application server 104 may access the secure content 108a on the resource server 108 by using the shared authentication credential. By way of example, the web application server 104 may transmit the authentication credential to the resource server 108A to access the secure content 108a. The resource server 108 may verify the received authentication credential with the hybrid authentication system 102. The web application server 104 may be allowed to access the secure content 108a on the resource server 108 based on the verification of the authentication credential by the resource server 108.

At 418, the web application server 104 may initialize a session of the web application 106 on the web client 114a of the user device 114 based on the accessed secure content 108a.

At 420, the web application server 104 may be further configured to assign a session ID to the initialized session on the web client 114a on the user device 114. The assigned session ID may be same as that for a sign-on based on a web-based login on the web client 114a. The session ID may be a unique number that the web application server 104 may assign to a session of the web application 106 on the web client 114a for a specific duration. The session ID may be specified in, for example, a cookie, a form field, or a Uniform Resource Locator (URL) on the web client 114a.

FIG. 5 is an example diagram that illustrates association among a user identifier, multiple user accounts, and multiple web accounts or multiple web-IDs, in accordance with an embodiment of the disclosure. FIG. 5 is explained in conjunction with elements from FIG. 1, FIG. 2, FIGS. 3A and 3B, and FIGS. 4A and 4B. With reference to FIG. 5, there is shown an example diagram 500.

The example diagram 500 includes a user identifier 502, multiple user accounts 504, and multiple web accounts 506. As shown, the multiple user accounts 504 may include, for example, a wallet account on the public ledger 112, a digital identity card, or a contactless smart card. Similarly, the multiple web accounts 506 may include, for example, an ID_Provider_1, an ID_Provider_2, an ID_Provider_3, and an ID_Provider_4. These multiple web accounts 506 may have respective web-IDs and may correspond to multiple identity providers who provide SSO-as-a-service to web applications that request access to secure content on respective resource servers, on behalf of a user.

An example of the multiple web accounts 506 and their respective type is provided in Table 4, as follows:

TABLE 4
Example of multiple web accounts

| Web Account | Type |
|---|---|
| ID_Provider_1 | Email-Service Provider |
| ID_Provider_2 | Social Media Network |
| ID_Provider_3 | Social Media Network |
| ID_Provider_4 | Email-Service Provider |

As shown, the user identifier 502, for example, an Email-ID, may be linked to each of the wallet account on the public ledger 112, the digital identity card, and the contactless smart card. The wallet account may be linked to the ID_Provider_1 and the ID_Provider_3. Similarly, the digital identity card may be linked to the ID_Provider_3 and the contactless identity card may be linked to the ID_Provider_2 and the ID_Provider_3. The multiple user accounts 504 may be owned by a single user and may allow a user to select a preferred user account and a preferred web account from the multiple user accounts 504 and the multiple web accounts 506, respectively. For example, a user input may be provided to select the wallet account on the public ledger 112 and the ID_Provider_3 as the identity provider 110 for SSO access to the web application 106, via the web client 114a on the user device 114.

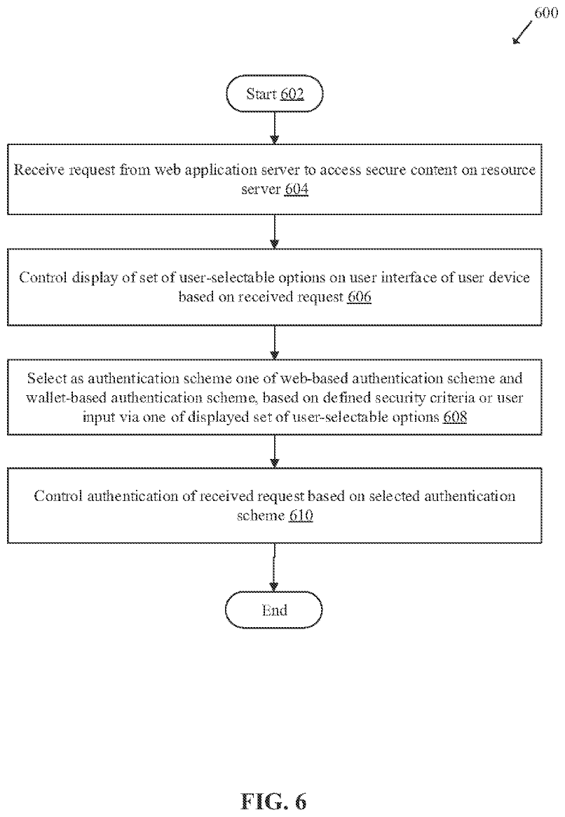

FIG. 6 is a flowchart that illustrates an exemplary method for SSO authentication via multiple authentication options, in accordance with an embodiment of the disclosure. FIG. 6 is described in conjunction with elements from FIGS. 1, 2, 3A, 3B, 4A, 4B, and 5. With reference to FIG. 6, there is shown a flowchart 600. The exemplary method of the flowchart 600 may be executed by any computing system, for example, by the hybrid authentication system 102. The exemplary method of the flowchart 600 may start at 602 and proceed to 604.

At 604, a request may be received from the web application server 104 to access the secure content 108a on the resource server 108. The hybrid authentication system 102 may be configured to receive the request from the web application server 104 to access the secure content 108a on the resource server 108. The web application server 104 may be further configured to transmit the request based on receipt of a user-initiated request for the SSO access to the web application 106 of the web application server 104.

At 606, a display of a set of user-selectable options may be controlled on the user interface of the user device 114 based on the received request. The hybrid authentication system 102 may be further configured to control the display of the set of user-selectable options on the user interface of the user device 114. The set of user-selectable options may correspond to the web-based authentication scheme and the wallet-based authentication scheme.

At 608, an authentication scheme may be selected as one of the web-based authentication scheme and the wallet-based authentication scheme, based on a defined security criteria or a user input via one of the displayed set of user-selectable options. The defined security criteria may include, but is not limited to, a defined security level for a specific web application of one or more web applications hosted on the web application server 104, a user preferred authentication scheme for the specific web application, or a failure status of the authentication attempted previously based on one of the web-based authentication scheme or the wallet-based authentication scheme. The hybrid authentication system 102 may be configured to select the authentication scheme as one of the web-based authentication scheme and the wallet-based authentication scheme.

At 610, authentication of the received request may be controlled based on the selected authentication scheme. The hybrid authentication system 102 may be further configured to control the authentication of the received request based on the selected authentication scheme. In case the web-based authentication scheme is selected, the hybrid authentication system 102 may be configured to control the authentication of the request in accordance with the web-based authentication. The web-based authentication may be based on the Oauth protocol. In case the wallet-based authentication scheme is selected, the hybrid authentication system 102 may be configured to control the authentication of the request in accordance with the wallet-based authentication scheme. The wallet-based authentication scheme may be based on the stored smart contract on the public ledger 112. Further details on the control of the authentication of received request is described, for example, in FIGS. 1, 4A, and 4B. The control may pass to end.

Various embodiments of the disclosure may provide a non-transitory, computer-readable medium and/or storage medium, and/or a non-transitory machine readable medium and/or storage medium stored thereon, instructions executable by a machine and/or a computer, such as a hybrid authentication system, for single-sign-on (SSO) authentication via multiple authentication options. The at least one code section may cause the machine and/or computer to perform operations that include reception of a request from a web application server to access secure content on a resource server. The hybrid authentication system may be communicatively coupled to the web application server and a public ledger that stores a smart contract. The operations further include control display of a set of user-selectable options on a user interface of a user device based on the received request. The set of user-selectable options may correspond to a web-based authentication scheme and a wallet-based authentication scheme. The wallet-based authentication scheme may be based on the stored smart contract on the public ledger. The operations further include selection of one of the web-based authentication scheme and the wallet-based authentication scheme as an authentication scheme, based on a defined security criteria or a user input via one of the displayed set of user-selectable options. The operations further include control of authentication of the received request based on the selected authentication scheme.

Exemplary aspects of the disclosure may include the hybrid authentication system 102 that includes the control circuitry 202 communicatively coupled to the web application server 104 and the public ledger 112. The public ledger 112 may store a smart contract. The control circuitry 202 may be configured to receive a request from the web application server 104 to access the secure content 108a on the resource server 108. The control circuitry 202 may be further configured to control display of a set of user-selectable options on a user interface of the user device 114 based on the received request. The set of user-selectable options may correspond to a web-based authentication scheme and a wallet-based authentication scheme. The wallet-based authentication scheme may be based on the stored smart contract on the public ledger 112. The control circuitry 202 may be further configured to select as an authentication scheme one of the web-based authentication scheme and the wallet-based authentication scheme, based on a defined security criteria or a user input via one of the displayed set of user-selectable options. The control circuitry 202 may be further configured to control authentication of the received request based on the selected authentication scheme. The control circuitry 202 may be further configured to share an authentication credential with the web application server 104 based on the authentication of the received request.

The web application server 104 may host one or more web applications and may provide the request based on receipt of a user-initiated request for a Single-Sign-On (SSO) access to the web application 106. The smart contract may be a self-executable program that stores a wallet address, an access token for the resource server 108, a user identifier, and a status identifier. The wallet address may be for a user's wallet account on the public ledger 112. The status identifier may indicate whether one of the wallet address or a wallet ID for the user's wallet account is linked or unlinked to a web-ID for the identity provider 110. The resource server 108 may be an application-programming interface (API) server that may be managed by the identity provider 110.

The web application server 104 may transmit an access request and user registration details to the hybrid authentication system 102 based on a user's access request from the web client 114a of the user device 114. The control circuitry 202 may be further configured to receive the access request and the user registration details transmitted by the web application server 104. The control circuitry 202 may be further configured to redirect the received access request to the identity provider 110 for authentication of the received access request. The control circuitry 202 may be further configured to receive an access token from the identity provider 110 based on authentication of the received access request. The control circuitry 202 may be further configured to store the received access token and the received user registration details securely via the smart contract on the public ledger 112.

The control circuitry 202 may be further configured to update the status identifier in the smart contract as unlinked. The updated status identifier may indicate one of the wallet address or the wallet ID for the user's wallet account is unlinked to the web-ID for the identity provider 110. The control circuitry 202 may be further configured to deploy an event listener on the public ledger 112. The control circuitry 202 may be further configured to detect, by the deployed event listener, one or more events associated with the stored smart contract on the public ledger 112.

The control circuitry 202 may be further configured to initiate a validation request for the received access token with the identity provider 110 based on the detected one or more events on the public ledger 112. The control circuitry 202 may be further configured to receive a response of the identity provider 110 for the initiated validation request. The control circuitry 202 may be further configured to validate the received access token based on the received response. The control circuitry 202 may be further configured to link the web-ID for the identity provider 110 with one of a public key, a wallet address or a wallet ID for the user's wallet account on the public ledger 112 based on the validation of the received access token.

The control circuitry 202 may be further configured to update the status identifier in the smart contract as linked based on the linkage. The control circuitry 202 may be further configured to link a plurality of web-IDs for a corresponding plurality of identity providers with one of a public key, a wallet address or a wallet ID for the user's wallet account on the public ledger 112. The control circuitry 202 may be further configured to update the status identifier in the smart contract as linked based on the linkage.

In accordance with an embodiment, the control circuitry 202 may be further configured to receive the user input via a first user-selectable option of the displayed set of user-selectable options for a selection of the web-based authentication scheme. The control circuitry 202 may be further configured to select the authentication scheme as the web-based authentication scheme based on the received user input. The control circuitry 202 may be further configured to control the authentication of the received request in accordance with the web-based authentication scheme. The web-based authentication scheme may be based on the Oauth protocol.

In accordance with an embodiment, the control circuitry 202 may be further configured to receive the user input via a second user-selectable option of the displayed set of user-selectable options for a selection of the wallet-based authentication scheme. The control circuitry 202 may be further configured to trigger a prompt on the web client 114a of the user device 114 based on the received user input. The prompt may be triggered so as to enable a user login to a user's wallet account using a wallet address and a private key associated with the wallet address for the user's wallet account. The control circuitry 202 may be further configured to detect, via the web client 114a on the user device 114, the user login to the user's wallet account. The control circuitry 202 may be further configured to control the authentication of the received request based on a public key associated with the wallet address and the detection of the user login. The public key may be stored on the hybrid authentication system 102.

The control circuitry 202 may be further configured to share an access credential with the web application server 104 based on the authentication of the received request. The web application server 104 may access the secure content 108a on the resource server 108 using the shared authentication credential. The web application server 104 may further initialize a session of the web application 106 on the web client 114a of the user device 114 based on the accessed secure content 108a. The web application server 104 may further assign a session ID to the initialized session. The assigned session ID may be same as that for a sign-on based on a web-based login.

The control circuitry 202 may be further configured to construct a user profile image based on the authentication of the received request. The user profile image may include an application Uniform Resource Locator (URL) for one or more web applications hosted on the web application server 104, an authentication type, an identity provider name, an expiration time pre-assigned to an access token, and a re-certification status. The defined security criteria may include a defined security level for a specific web application of one or more web applications hosted on the web application server 104, a user preferred authentication scheme for the specific web application, or a failure status of the authentication attempted previously based on one of the web-based authentication scheme or the wallet-based authentication scheme.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departure from its scope. Therefore, it is intended that the present disclosure not be limited to the particular embodiment disclosed, but that the present disclosure will include all embodiments that fall within the scope of the appended claims.

1. A hybrid authentication system, comprising:
control circuitry communicatively coupled to a web application server and a public ledger that stores a smart contract,
wherein the control circuitry is configured to:
receive a request from the web application server to access secure content on a resource server;
control display of a set of user-selectable options on a user interface of a user device based on the received request,
wherein the set of user-selectable options corresponds to a web-based authentication scheme and a wallet-based authentication scheme, and
the wallet-based authentication scheme is based on the stored smart contract on the public ledger;
select as an authentication scheme one of the web-based authentication scheme and the wallet-based authentication scheme, based on a defined security criteria or a user input via one of the displayed set of user-selectable options; and
control authentication of the received request based on the selected authentication scheme.

2. The hybrid authentication system according to claim 1, wherein the web application server hosts at least one web application, and
wherein the web application server provides the request based on receipt of a user-initiated request for a Single-Sign-On (SSO) access to the at least one web application.

3. The hybrid authentication system according to claim 1, wherein the smart contract is a self-executable program that stores a wallet address, an access token for the resource server, a user identifier, and a status identifier,
wherein the wallet address is for a user's wallet account on the public ledger, and
wherein the status identifier indicates one of the wallet address or a wallet identity (ID) for the user's wallet account is linked or unlinked to a web-ID for an identity provider.

4. The hybrid authentication system according to claim 1, wherein
the resource server is an application-programming interface (API) server that is managed by an identity provider, and
the resource server stores user-specific information as the secure content.

5. The hybrid authentication system according to claim 1, wherein the web application server transmits an access request and user registration details to the hybrid authentication system based on a user's access request from a web client of the user device.

6. The hybrid authentication system according to claim 5, wherein the control circuitry is further configured to:
receive the access request and the user registration details transmitted by the web application server;
redirect the received access request to an identity provider for authentication of the received access request; and
receive an access token from the identity provider based on authentication of the received access request.

7. The hybrid authentication system according to claim 6, wherein the control circuitry is further configured to:
store the received access token and the received user registration details securely via the smart contract on the public ledger; and
update a status identifier in the smart contract as unlinked, wherein the updated status identifier indicates one of a wallet address or a wallet identity (ID) for a user's wallet account is unlinked to a web-ID for the identity provider.

8. The hybrid authentication system according to claim 7, wherein the control circuitry is further configured to:
deploy an event listener on the public ledger; and
detect, by the deployed event listener, one or more events associated with the stored smart contract on the public ledger.

9. The hybrid authentication system according to claim 8, wherein the control circuitry is further configured to:
initiate a validation request for the received access token with the identity provider based on the detected one or more events on the public ledger;
receive a response of the identity provider for the initiated validation request; and
validate the received access token based on the received response.

10. The hybrid authentication system according to claim 9, wherein the control circuitry is further configured to:
link a web-ID for an identity provider with a wallet address or a wallet ID for the user's wallet account on the public ledger based on the validation of the received access token; and
update the status identifier in the smart contract as linked based on the linkage.

11. The hybrid authentication system according to claim 9, wherein the control circuitry is further configured to:
link a plurality of web-IDs for a corresponding plurality of identity providers with a wallet address or a wallet ID for the user's wallet account on the public ledger; and
update the status identifier in the smart contract as linked based on the linkage.

12. The hybrid authentication system according to claim 1, wherein the control circuitry is further configured to:
receive the user input via a first user-selectable option of the displayed set of user-selectable options for a selection of the web-based authentication scheme;
select the authentication scheme as the web-based authentication scheme based on the received user input; and
control the authentication of the received request in accordance with the web-based authentication scheme,
wherein the web-based authentication scheme is based on an Oauth protocol.

13. The hybrid authentication system according to claim 1, wherein the control circuitry is further configured to:
receive the user input via a second user-selectable option of the displayed set of user-selectable options for a selection of the wallet-based authentication scheme;
trigger a prompt on a web client of the user device based on the received user input,
wherein the prompt is triggered so as to enable a user login to a user's wallet account using a wallet address and a private key associated with the wallet address for the user's wallet account;
detect, via the web client on the user device, the user login to the user's wallet account; and
control the authentication of the received request based on a public key associated with the wallet address, the detection of the user login, and the stored smart contract,
wherein the public key is stored on the hybrid authentication system.

14. The hybrid authentication system according to claim 1, wherein the control circuitry is further configured to share an access credential with the web application server based on the authentication of the received request.

15. The hybrid authentication system according to claim 14, wherein the web application server:
accesses the secure content on the resource server using the shared authentication credential; and
initializes a session of the web application on a web client of the user device based on the accessed secure content; and
assigns a session ID to the initialized session, wherein the assigned session ID is same as that for a sign-on based on a web-based login.

16. The hybrid authentication system according to claim 1, wherein the control circuitry is further configured to construct a user profile image based on the authentication of the received request, wherein the user profile image comprises an application Uniform Resource Locator (URL) for at least one web application hosted on the web application server, an authentication type, an identity provider name, an expiration time pre-assigned to an access token, and a re-certification status.

17. The hybrid authentication system according to claim 1, wherein the defined security criteria comprises a defined security level for a specific web application of at least one web application hosted on the web application server, a user preferred authentication scheme for the specific web application, or a failure status of the authentication attempted previously based on one of the web-based authentication scheme or the wallet-based authentication scheme.

18. A method, comprising:
in a hybrid authentication system communicatively coupled to a web application server and a public ledger that stores a smart contract:
receiving a request from the web application server to access secure content on a resource server;
controlling display of a set of user-selectable options on a user interface of a user device based on the received request,
wherein the set of user-selectable options corresponds to a web-based authentication scheme and a wallet-based authentication scheme, and
the wallet-based authentication scheme is based on the stored smart contract on the public ledger;
selecting as an authentication scheme one of the web-based authentication scheme and the wallet-based authentication scheme, based on a defined security criteria or a user input via one of the displayed set of user-selectable options; and
controlling authentication of the received request based on the selected authentication scheme.

19. The method according to claim 18, further comprising:
receiving the user input via a first user-selectable option of the displayed set of user-selectable options for a selection of the web-based authentication scheme;
selecting the authentication scheme as the wallet-based authentication scheme based on the received user input; and
controlling the authentication of the received request in accordance with the web-based authentication scheme,
wherein the web-based authentication scheme is based on an Oauth protocol.

20. The method according to claim 18, further comprising:
receiving the user input via a second user-selectable option of the displayed set of user-selectable options for a selection of the wallet-based authentication scheme;
triggering a prompt on a web client of the user device based on the received user input,
wherein the prompt is triggered so as to enable a user login to a user's wallet account using a wallet address and a private key associated with the wallet address for the user's wallet account;
detecting, via the web client on the user device, the user login to the user's wallet account; and
controlling the authentication of the received request based on a public key associated with the wallet address, the detection of the user login, and the stored smart contract,
wherein the public key is stored on the hybrid authentication system.

21. A non-transitory computer-readable medium having stored thereon, computer-executable instructions that when executed by a hybrid authentication system, causes the hybrid authentication system to execute operations, the operations comprising:
receiving a request from a web application server to access secure content on a resource server;
controlling display of a set of user-selectable options on a user interface of a user device based on the received request,
wherein the set of user-selectable options corresponds to a web-based authentication scheme and a wallet-based authentication scheme, and
the wallet-based authentication scheme is based on a smart contract on a public ledger;
select as an authentication scheme one of the web-based authentication scheme and the wallet-based authentication scheme, based on a defined security criteria or a user input via one of the displayed set of user-selectable options; and
control authentication of the received request based on the selected authentication scheme.
